(19) United States
(12) Patent Application Publication
(10) Pub. No.: US 2025/0312798 A1
(43) Pub. Date: Oct. 9, 2025

(54) HORIZONTAL SHAFT IMPACT CRUSHER

(71) Applicant: SANDVIK LTD, Dungannon (GB)

(72) Inventors: Terry MCDEVITT, Dungannon (GB); Stuart SMYTH, Dungannon (GB)

(21) Appl. No.: 18/866,162

(22) PCT Filed: May 23, 2023
(86) PCT No.: PCT/EP2023/063851

§ 371 Date: Nov. 15, 2024

(30) Foreign Application Priority Data
May 24, 2022 (EP) 22174967.4

(51) Int. Cl. B02C 13/09; B02C 25/00

(52) U.S. Cl. CPC B02C 13/095; B02C 25/00; B02C 2210/00

(57) ABSTRACT

A horizontal shaft impact crusher and method for adjusting the same is provided. The crusher housing has an inlet for receiving material to be crushed and an outlet for material that has been crushed. The crusher housing includes an impeller, which is mounted on a horizontal shaft and which is operative for rotating around a horizontal axis, a curtain against which material accelerated by the impeller may be crushed, and an adjustment device including an adjustment bar for adjusting the position of the curtain relative to the impeller, a cross beam to which the adjustment bar is connected, the crossbeam being adjustable relative to the impeller, and a drive cylinder arranged for displacing the cross beam to set the position of the curtain relative to the impeller. The drive cylinder includes an internally mounted sensor to measure the curtain position relative to the impeller.

### FIELD

The present invention relates to a horizontal shaft impact crusher comprising a crusher housing having an inlet for material to be crushed, an outlet for material that has been crushed, an impeller being mounted on a horizontal shaft in the crusher housing and being operative for rotating around a horizontal axis, a curtain against which material accelerated by the impeller may be crushed, and an adjustment bar for adjusting the position of said curtain relative to the impeller. The present invention further relates to a method for adjusting a horizontal shaft impact crusher.

### BACKGROUND

Horizontal shaft impact crushers are utilized in many applications for crushing hard material. Such as pieces of rock, ore etc. A horizontal shaft impact crusher has an impeller that is made to rotate around a horizontal axis. Pieces of rock are fed towards the impeller and are struck by beater elements mounted on the impeller. The pieces of rock are disintegrated by being struck by the beater elements, and are accelerated and thrown against breaker plates, often referred to as curtains, against which further disintegration occurs.

The action of the impeller thus causes the material fed to the horizontal shaft impact crusher to move freely in a crushing chamber and to be crushed upon impact against the beater elements, against the curtains, and against other pieces of material moving around at high speed in the crushing chamber.

Furthermore, adjustment of the position of the curtain may be made to compensate for both curtain wear and beater element wear. Adjustment of the position of the curtain may be also made to adjust the size of the crushed material.

It is known to manually set the closed side setting gap (CSS). This requires machine downtime and a lot of human intervention to ensure the required gap setting is achieved to obtain a specific final product. Although this setting can be achieved by the use of adjustable actuators the measurement of the gap (CSS) is derived by traditional measurement methods, a tape measure for example. In order to measure the gap (CSS) the crusher power source (engine/motor) has to be disengaged to do the measurement safely.

Once the crusher has come to a stop (fully isolated from power source) the rotor has to be indented to the correct position adjacent to the curtain. A mechanical rotor positioning device is commonly used to ensure the rotor is indented in a safe manner prior to the measurement being taken.

US2013/0146692 describes an apparatus and method for adjusting the curtains in an impact crusher which uses a sensor arranged on the cross beam of the impact crusher to measure curtain position. This is a line-of-sight sensor which is mounted externally to the v-block and gives a measure of the distance that may allow calculation of curtain position, not a direct measurement. The apparatus and method of US2013/0146692 requires significant machine downtime to manually set the CSS.

Historically it is known that the curtain liners wear at a reduced rate when compared to the crushing hammers or beaters attached to the rotor. However, it is difficult to measure the independent wear rates between these items.

### SUMMARY

It is an object of the invention to remove the need for excessive machine downtime. It is another object of the present invention to eliminate human intervention when obtaining a CSS measurement.

Objects of the invention have been achieved by the invention set forth in appended independent claims 1 and 18. Further preferred embodiments are set forth in the appended dependent claims and in the description.

In accordance with a first aspect of the invention there is provided a horizontal shaft impact crusher comprising:
a crusher housing having an inlet for material to be crushed, an outlet for material that has been crushed, an impeller being mounted on a horizontal shaft in the crusher housing and being operative for rotating around a horizontal axis, a curtain against which material accelerated by the impeller may be crushed, and an adjustment device comprising an adjustment bar for adjusting the position of the curtain relative to the impeller; a cross beam to which the adjustment bar is connected. The crossbeam is adjustable relative to the impeller. The adjustment device further comprising a drive cylinder for displacing the cross beam to set the position of the curtain relative to the impeller. The drive cylinder comprises an internally mounted sensor to measure the curtain position relative to the impeller.

Preferably, the drive cylinder is a hydraulic drive cylinder. A hydraulic drive cylinder is easy to control and easy to maintain.

Preferably, the internally mounted sensor is centrally mounted in the drive cylinder. Centrally mounting the sensor creates a compact design and integrates it in the drive cylinder.

Preferably, the internally mounted sensor is a magnetostrictive linear position sensor. A magnetostrictive sensor is exceptionally shock resistant, waterproof, operates over a wide temperature and pressure range, provides suitable resolution and measurement length.

Preferably, the internally mounted sensor measures stroke distance of the drive cylinder. Measurement of stroke distance assists with determining the lifespan of components.

Preferably, measurement of the stroke distance provides a linear distance between an impeller beater element and the curtain. Measurement of a linear distance improves measurement accuracy.

Preferably, measurement of the stroke distance provides a measure of wear on the curtain. This measurement of wear allows for adjustment of the position of the curtain.

Preferably, measurement of the stroke distance is constantly measured by the internally mounted sensor. Constant measurement allows for real time adjustment of curtain position.

Preferably, measurement of the stroke distance coupled with predetermined set points is used to set the position of the curtain with respect to the impeller beater element to give requested CSS. This allows for accurate control of the size of the product leaving the machine.

Preferably, the drive cylinder further comprises a control block configured to reroute fluid from the fluid within the holding side to a retraction side of the cylinder. Rerouting fluid provides for adjustment of curtain position.

Preferably, the control block reroutes fluid from the fluid within the holding side to a retraction side of the cylinder, in response to an overload pressure, via relief valve. Rerouting fluid minimises damage which may be caused by an overload pressure.

Preferably, the control block further comprises a pressure sensor configured to measure a mechanical load acting on the curtain. The pressure sensor assists with positioning of the curtain.

In any embodiment, the drive cylinder may be connected to the crusher housing and to the cross beam. By this configuration, the drive cylinder is arranged on an exterior side of the crusher housing.

In particular, the drive cylinder may be connected, such as directly attached, at a proximal portion thereof to the crusher, such as the crusher housing, and at a distal portion of the drive cylinder connected, such as directly attached, to the cross beam.

In any embodiment, the adjustment device may be configured such that the cross beam is displaceable during crushing operations, such as slidably attached to the crusher. The cross beam may be displaceable in a proximal direction and in an opposite distal direction during crushing operations. The cross beam may be displaceable in a proximal direction and in an opposite distal direction during crushing operations by means of the drive cylinder.

In accordance with a second aspect of the invention there is provided a method for adjusting a horizontal shaft impact crusher comprising a crusher housing having an inlet for material to be crushed, an outlet for material that has been crushed, an impeller being mounted on a horizontal shaft in the crusher housing and being operative for rotating around a horizontal axis, a curtain against which material accelerated by the impeller may be crushed, and an adjustment device for adjusting the position of said curtain relative to the impeller, the method comprising:
moving, by means of a drive cylinder the curtain into a position at which the curtain is in contact with an impeller beater element, measuring the stroke of the drive cylinder using a sensor which is internally mounted in the drive cylinder to calculate the position of the curtain relative to the impeller beater element. The present invention improves the measurement and control of curtain position.

Preferably, measurement of the stroke distance provides a measure of wear on the curtain. Measurement of stroke distance assists with determining the lifespan of components.

Optionally, measurement of the stroke distance is used to set the position of the curtain with respect to the impeller beater element. This allows for accurate control of the size of the product leaving the machine.

According to embodiments, the method comprises, and the crusher may correspondingly be configured to carry out any or all of of: —periodically providing a wear measurement and storing said measurements; —calculating, using said stored measurements, a wear rate of liners and beater elements.

According to embodiments, the method comprises, and the crusher may correspondingly be configured to carry out any or all of: using the stored wear measurements, calculate an estimated lifespan of the liners and beater elements.

In any embodiment, the crusher may comprise a machine programmable logic controller (PLC) for carrying out the method according to the disclosure.

According to embodiments, the method comprises, and the crusher may correspondingly be configured to carry out any or all of: continually monitoring the CSS; compensating for said total combined wear within the PLC to ensure accurate CSS setting.

According to embodiments, the method comprises, and the crusher may correspondingly be configured to carry out any or all of: continually monitoring of the CSS and predicting wear rates for a user specific application; optionally, provide an indication as to when the wear parts need replacing.

According to embodiments, the method comprises, and the crusher may correspondingly be configured to carry out any of all of: determining a value of liner wear after a beater change; recording said value of liner wear; calculating liner wear over time; extrapolating said liner wear over time to provide predicted liner wear rates.

### BRIEF DESCRIPTION OF THE DRAWINGS

The invention will be more clearly understood from the following description of an embodiment thereof, given by way of example only, with reference to the accompanying drawings, in which:

FIG. 1 is a front perspective view of a crusher according to an embodiment of the present invention;

FIG. 2 is a perspective view of an adjustment device of the crusher of FIG. 1;

FIG. 3 is a rear perspective view of the adjustment device of the crusher shown in FIG. 1;

FIG. 4 is a cross section side view of the crusher shown in FIG. 1;

FIG. 5 is a plan cross sectional view of the adjustment device shown in FIG. 2;

FIG. 6 is a plan view of the adjustment device shown in FIG. 2;

FIG. 7 is a rear view of the adjustment device shown in FIG. 2;

FIG. 8a is a perspective view, FIG. 8b is a plan view and FIG. 8c is a side view of a drive cylinder according to an embodiment of the present invention;

FIG. 9 shows a perspective view of a magnetostrictive transducer;

FIG. 10 is a graph of CSS setting plotted against cylinder stroke; and

FIG. 11 is a schematic diagram which illustrates an example of a fluid circuit used in conjunction with a cylinder in accordance with the present invention.

### DETAILED DESCRIPTION OF THE DRAWINGS

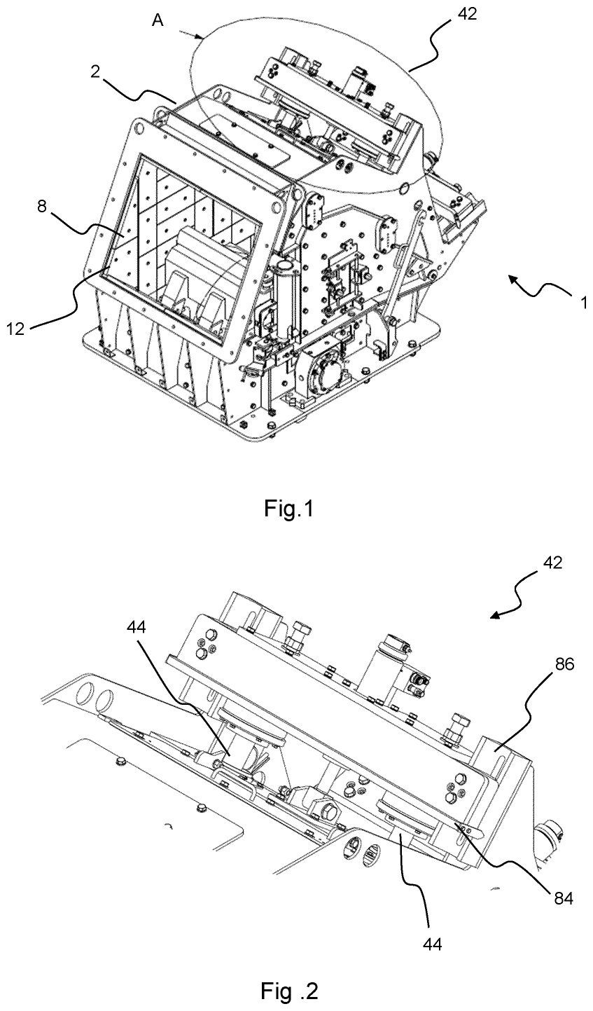

The following description of an impact crusher, in particular with reference to FIGS. 1 to 4, is intended to set out the general features of an example of an impact crusher in accordance with the present invention.

FIG. 1 illustrates, schematically, a horizontal shaft impact crusher 1. The horizontal shaft impact crusher 1 comprises a housing 2 in which an impeller 4 is arranged. A motor, not illustrated for reasons of maintaining clarity of illustration, is operative for rotating a horizontal shaft 6 on which the impeller 4 is mounted. As alternative to the impeller 4 being fixed to the shaft 6, the impeller 4 may rotate around the shaft 6. In either case, the impeller 4 is operative for rotating around a horizontal axis, coinciding with the center of the horizontal shaft 6.

Material to be crushed is fed to an inlet 8 for material to be crushed. The crushed material leaves the crusher 1 via an outlet 10 for material that has been crushed.

The housing 2 is provided with a plurality of wear protection plates 12 that are operative for protecting the walls of the housing 2 from abrasion and from impact by the material to be crushed. Furthermore, the housing 2 comprises a bearing 14 for the horizontal shaft 6. A lower feed plate (not shown) and an upper feed plate (not shown) are arranged at the inlet 8. The feed plates are operative for providing the material fed to the crusher 1 with a suitable direction with respect to the impeller 4.

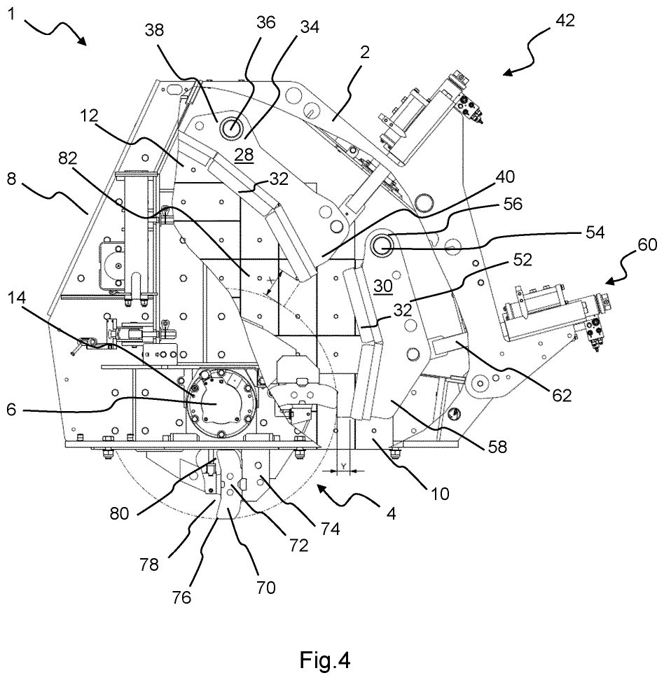

As illustrated in FIG. 4, the crusher 1 comprises a first curtain 28, and a second curtain 30. Each curtain 28, 30 comprises at least one wear plate 32 against which material may be crushed.

A first end 34 of the first curtain 28 has been mounted by means of a horizontal first pivot shaft 36 extending through an opening 38 formed in said curtain 28 at said first end 34. The first pivot shaft 36 extends further through openings in the housing 2 to suspend said first end 34 in said housing 2. A second end 40 of said first curtain 28 is connected to a first adjustment device 42 comprising two parallel adjustment bars 44 FIG. 2.

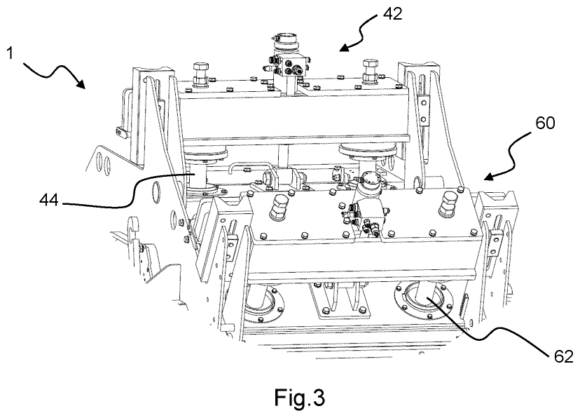

A first end 52 of the second curtain 30 has been mounted by means of a horizontal second pivot shaft 54 extending through an opening 56 formed in said curtain 30 at said first end 52. The second pivot shaft 54 extends further through openings in the housing 2 to suspend said first end 52 in said housing 2. A second end 58 of said second curtain 30 is connected to a second adjustment device 60 comprising two parallel adjustment bars 62. The second adjustment device 60 may be of a similar design as the first adjustment device 42 and are shown in FIGS. 2 and 3.

The illustrated impeller 4 has four beater elements 70, each such beater element 70 having a bent shape, as seen in cross-section. Each beater element 70 has a central portion 72 which is operative for co-operating with a mounting block 74 being operative for pressing the back of the beater element 70 towards the impeller 4 to keep the beater element 70 in position. A leading edge 76 of the beater element 70 extends in the direction of rotation, such that a scoop-area 78 is formed between the central portion 72 and the leading edge 76.

The beater element 70 is symmetric around its central portion 72, such that once the leading edge 76 has been worn out, the beater element 70 can be turned and mounted with its second leading edge 80 operative for crushing material. The area formed between the impeller 4 and the first and second curtains 28, 30 can be called a crushing chamber 82 of the crusher 1.

The material will first reach the first curtain 28, being located upstream of the second curtain 30 as seen with respect to the direction of travel of the material. By means of the feed plates the material is directed towards the impeller 4 rotating at, typically, 400-850 rpm. When the material is hit by the beater elements 70 it will be crushed and accelerated against the wear plates 32 of the first curtain 28 where further crushing occurs. The material will bounce back from the first curtain 28 and will be crushed further against material travelling in the opposite direction and, again, against the beater elements 70. When the material has been crushed to a sufficiently small size it will move further down the crusher chamber 82 and will be accelerated, by means of the beater elements 70, towards the wear plates 32 of the second curtain 30, being located downstream of the first curtain 28. Hence, the material will move freely around in the crushing chamber 82 and will be crushed against the beater elements 70, against the wear plates 32 of the curtains 28, 30, and against other pieces of material circling around, at a high velocity, in the crusher 1.

By adjusting the longitudinal position of the adjustment bar 44 in relation to the housing 2, the first curtain 28 may be pivoted around the first pivot shaft 36 until an optimum distance between the second end 40 and the impeller 4 has been obtained, with respect to the properties, as regards, e.g., size and hardness, of the material to crushed. Hence, the adjustability of the distance between the first curtain 28 and the impeller 4 is smallest at that location, i.e., at the second end 40 of the first curtain 28, where the distance between the first curtain 28 and the impeller 4 is normally the smallest. In a similar manner the second adjustment device 60 may be utilized for making the second curtain 30 pivot around the second pivot shaft 54 until a suitable distance between the impeller 4 and the second end 58 of the second curtain 30 has been obtained.

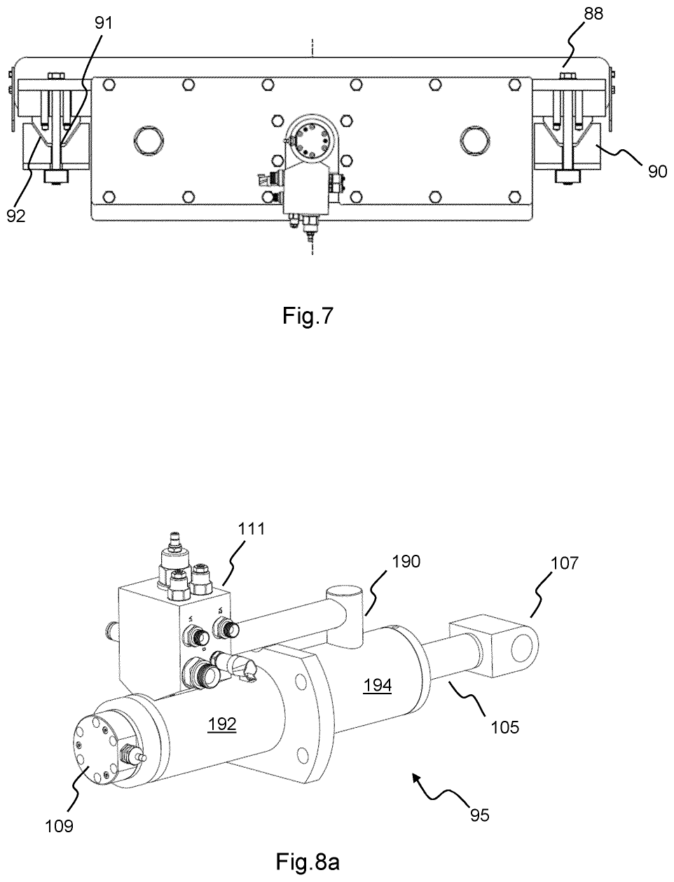

As illustrated in FIGS. 2, 3 and 5-7 the adjustment device 42 comprises a supporting structure, in the form of a cross beam 84, and two connection portions, in the form of V-shaped guide blocks 86, which are arranged in opposite horizontal ends of the cross beam 84 and are fastened to the crossbeam 84. Each of the two guide blocks 86 is received in a respective guide rail 90 mounted on the housing 2 and extending away from the housing 2. Each guide rail 90 is provided with portion having a shape that corresponds to the shape of the connection part of the cross beam 84. In this embodiment each guide rail 90 is provided with a V-shaped groove 91 to form a V-shaped receiving portion that corresponds to the V-shaped guide block 86, as is best illustrated in FIG. 7.

The guide blocks 86 can slide along the guide rails 90. Adjustment of the cross beam 84, and thereby of the curtain 28 which is connected to the cross beam 84 via the bars 44, to a correct position in relation to the impeller 4 with respect to the properties of the material to be crushed may be carried out by adjusting the position of cross beam 84 by having the guide blocks 86 slide relative to the guide rails 90.

As illustrated in FIG. 7 the crusher 1 further comprises retaining means, in the form of retaining bolts 88. Optionally, the groove 91, and/or the guide block 86, may be provided with a friction pad 92.

The friction pad 92, which may be, for example a proprietary disk brake lining material, provides a large and predictable friction force between the guide block 86 and the guide rail 90.

Each guide rail 90 is provided with a longitudinal slot 94, as is best illustrated in FIGS. 6 and 7, which slot 94 extends along the guide rail 90 and is configured to receive the retaining means, in this case the retaining bolt 88, for tightening the guide block 86 to the guide rail 90. The slot 94 makes it possible for the guide block 86 with the retaining bolt 88 mounted therein to slide along the guide rail 90.

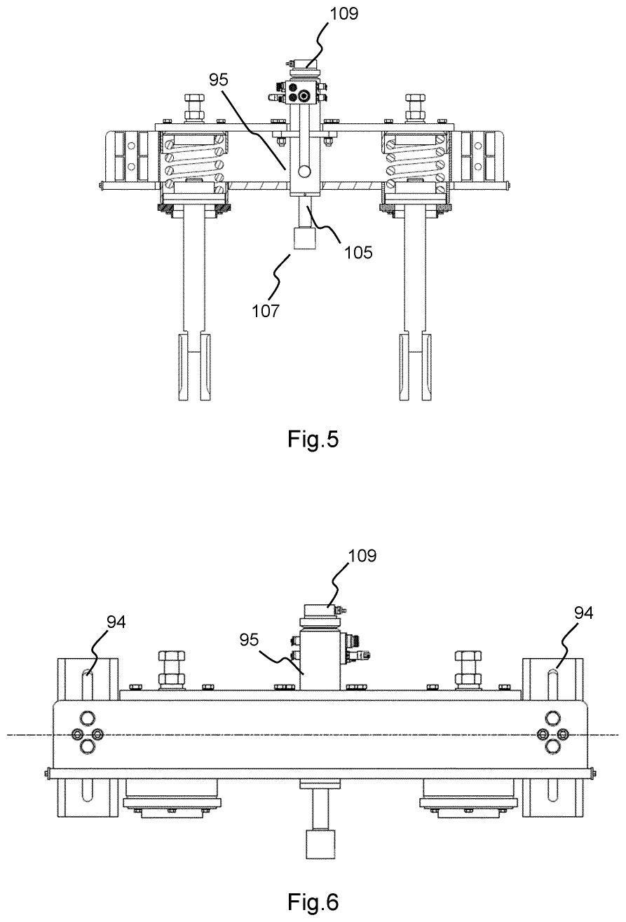

Features of the invention as described in relation to the embodiments described herein, and its various modes of operation will now be described with reference to FIGS. 5 to 11.

As shown in FIGS. 5 to 8 the drive cylinder 95 is positioned centrally upon the adjustment device 42,60. The drive cylinder comprises a piston shaft 105 with a coupling 107 which is abuttable against the crusher housing 2.

Transducer 109 is mounted centrally in the cylinder 95 and measures the curtain position relative to the impeller 4. The position of the curtain 28,30 is adjustable relative to the impeller 4.

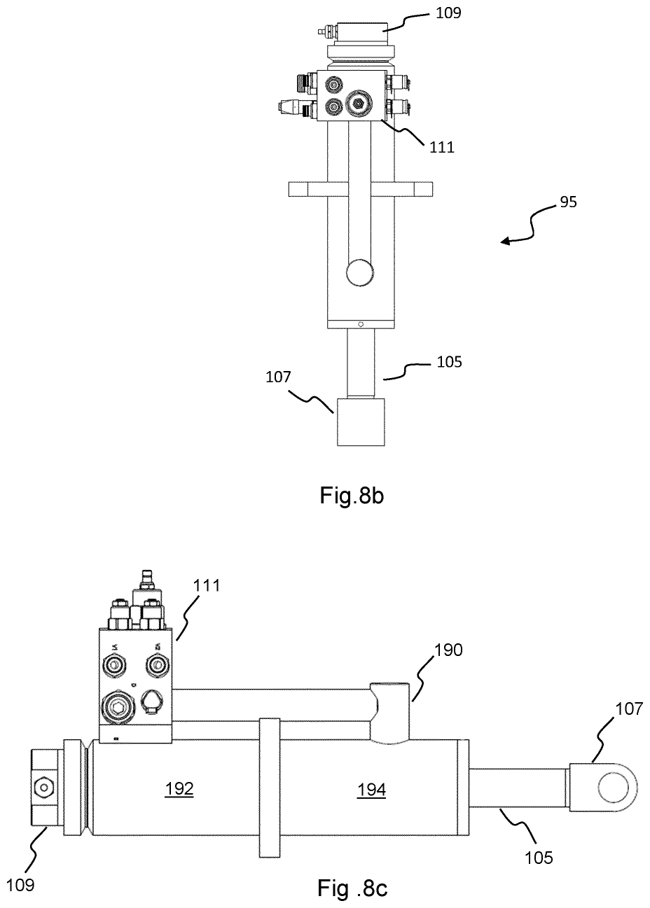

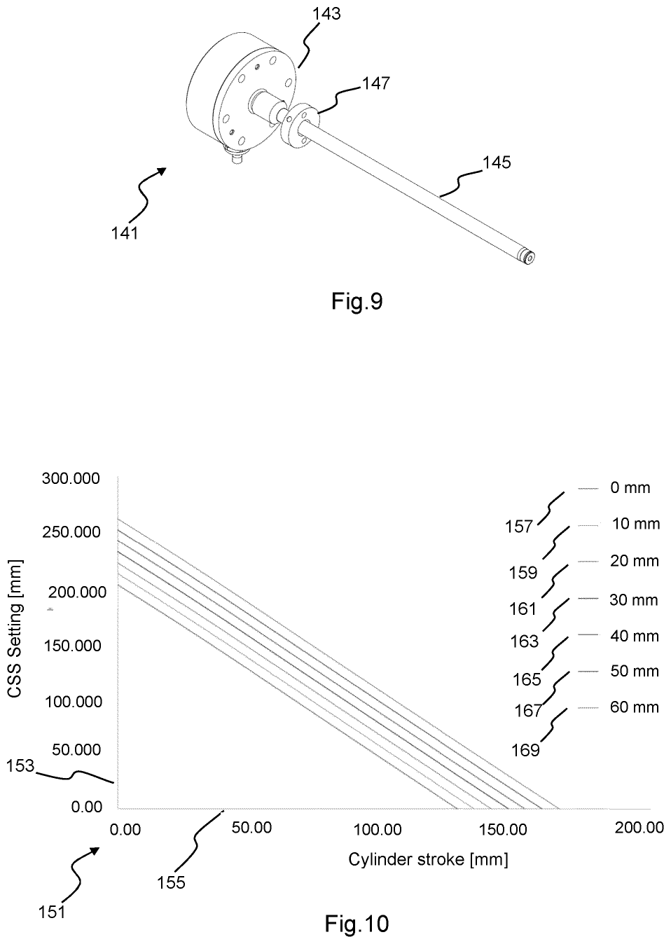

In this example of the present invention, the sensor 109 and 141 FIG. 8a and FIG. 9 is mounted centrally in the cylinder 95 and comprises a linear displacement sensor which detects the cylinder rod/piston 105 position relative to the cylinder 95. In this example of the present invention, the linear displacement sensor 141 is a magnetostrictive linear position sensor suitable for use in extreme environments rugged steal housing. It comprises a magnet 147 mounted on a probe shaft 145. The magnetostrictive sensor is exceptionally shock resistant, extremely waterproofness, an operational temperature range of −40 to +85 deg C., a pressure resistance rated up to 1000 Bar, resolution to 1 micron and a suitable measurement length for the application.

The sensor 141 measures the cylinder extension/position and the signal from this sensor is used to derive the CSS via the machine programmable logic controller (PLC). The cylinder 95 position can also be set via the machine programmable logic controller PLC.

In addition to the linear displacement sensor 141, the cylinder 95 has an integral pressure sensor 189 to detect external load on the curtain as shown in FIGS. 8a to 8c. The pressure sensor 189 is mounted on the hydraulic coupling 111 which forms part of a hydraulic circuit which connects 190 to the bore side 192 and the annulus side 194 of the cylinder.

In use, the drive cylinder 95 is held under pressure to set the position of the curtain 30. The pressure sensor 189 measures the pressure in the cylinder to assist with the positioning of the curtain 30 with respect to the impeller 70 because it can detect excess pressure when the curtain comes in contact with the impeller 70 as it is pushed forward. The drive cylinder pressure is constantly measured by the pressure sensor 189 and the pressure sensor 189 can detect overload pressure.

Wear calibration is conducted periodically, from this, each wear measurement will be stored within the machine PLC. Plotting this against crushing hours which is also stored will give a wear rate of liners and beater elements within their current application. Using a few other parameters such as engine load and product output (TPH), an estimation of the lifespan of the liners and beater elements under predefined conditions may be obtained. The wear life given in time will be presented to the customer and allow them to order replacement liners at the correct time.

An example of the wear setting procedure for the present invention is as follows.

The procedure comprises four stages:
1. Sensor Calibration (Zero condition—applies to both Bottom & Top Curtain)
2. Determining Wear Value
3. Bottom Curtain CSS
4. Top Curtain CSS

FIG. 10 is a graph which plots CSS setting 153 against wear 155 and shows a family of curves 151 for wear values of 0 mm 157, 10 mm 159, 20 mm 161, 30 mm 163, 40 mm 165, 50 mm 167 and 60 mm 169. FIG. 10 provides an example of the type of calibration graph which may be used to calculate wear.

In stage 1, setting Zero Condition of adjustment device 60, the following steps may be undergone.

A combination of transducer 141 and pressure sensor 189 are used to calibrate the device to set zero condition. Bore side 192 of the cylinder 95 is energized and the cylinder extended to full stroke. The pressure transducer 189 will detect a drop in pressure on the annulus side 185. The electrical current value measured in the linear transducer 109 will increase or decrease from its initial condition until full stroke is achieved. Once the electrical current measured at the linear transducer 109 is within a specified window and assuming that the full stroke has been achieved and all offsets have been compensated for, sensor calibration is complete.

In stage 2 the annulus side 194 of the cylinder 95 is energized and the cylinder 95 retracted until impact with hammer tip or beater tip is achieved. The pressure transducer 189 will detect a pressure spike on impact on the annulus side and the linear transducer 109,141 position value is recorded and compared to a look up table of wear values—Using linear computation the total wear value is calculated.

In stage 3, bottom curtain CSS may be set as follows. The CSS is set/determined using the wear value previously calculated where an automatic procedure on calibration request or during normal operation (after wear value is previously stored). The bore side 192 of the cylinder is energized and the cylinder extends until the electrical current value measured by the linear transducer 141 matches the requested value by the user. The cylinder stops moving and CSS is set.

In stage 4, the top curtain CSS may be set using adjustment device 42 following the same procedure as Step 1 and Step 3 above.

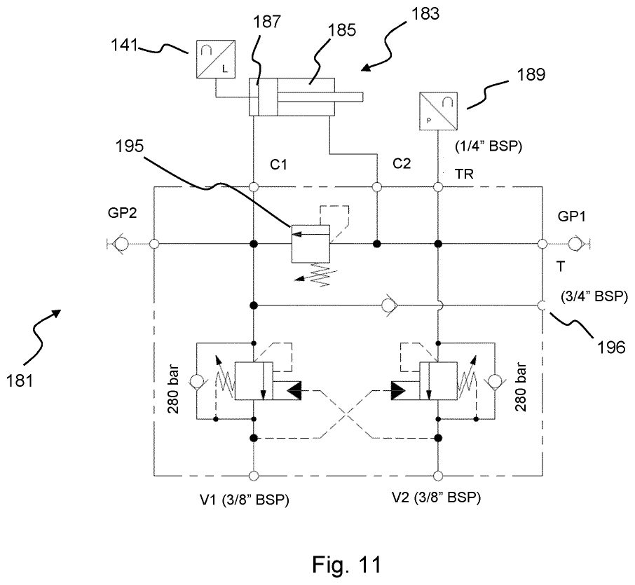

FIG. 11 is a schematic diagram which illustrates an example of a fluid circuit used in conjunction with a cylinder in accordance with the present invention. The fluid circuit 181 comprises a drive cylinder 183 with a holding side 185 and a retraction side 187. The circuit is used to monitor the pressure within the fluid circuit which acts as a measure of the load experienced by the curtains 28 & 30 of the crusher.

In one example, when extremely high shock loads are present, or an uncrushable item enters the chamber, the mechanical load on the curtains 28 & 30 will increase. This increase occurs so rapidly that the system is unable to adjust in time hence a fast-acting relief valve 195 is used within fluid circuit 181. The relief valve 195 reroutes the fluid extremely quickly from the holding side 185 to the retraction side 187 of the cylinder 95. It is using the latent energy of the shock load to retract the cylinder rather than totally relying on an external pump for example. Furthermore, the fluid circuit 181 is configured to draw any additional fluid from tank line 196 to ensure cavitation is prevented.

In a further example, if the load within the crushing chamber 1 increases to a level above the desired operating conditions of the machine. Pressure sensor 189 will detect this increase and report to the PLC, the PLC will subsequently send a signal to energize the retraction side 187 of the cylinder 95. This opens the CSS gap and reduces pressure. Once this pressure has been reduced to an allowable level the PLC will energize the holding side 185 to reset the CSS setting.

Advantageously, the present invention can fully carry out the CSS measurement using PLC logic.

The benefits include reduced downtime as the crusher power source does not need to be fully isolated. The operator is not required to carry out any manual tasks including brake release, access door opening/closing, engaging of rotor turning device and manually positioning of the curtains as well as the measurement of the gap (CSS). The removal of these tasks inherently reduces the risk to the operator and reduces downtime.

The transducers are positioned integrally to the driving hydraulic cylinder, they are bolted onto the end of the hydraulic cylinder with an internal rod slid inside the cylinder.

The transducers 141 measure the overall stroke of the driving cylinder, from this measurement we can directly calculate the position of the curtain. In the maintenance mode of the machine the impeller 4 is turned at a reduced rpm. This hydraulic cylinder is used to position curtain to the desired gap (CSS).

Unlike the prior art, the adjustment device 42 is not clamped tight through the V-blocks 86 instead is held in position determined by the cylinder extension. Varying V-block friction materials could be used to reduce/increase load transmission on the hydraulic cylinder by decreasing/increasing friction factor. This can be beneficial in heavy duty applications where the load transfer to the cylinder can be reduced hence increasing cylinder service life.

Thus, the adjustment device is configured such that the cross beam is displaceable during crushing operations, in particular slidably attached to the crusher. The cross beam is displaceable in a proximal direction towards the crusher and in an opposite distal direction during crushing operations. The cross beam is displaceable in the proximal direction and in the distal direction during by means of the drive cylinder.

In at least one example of the present invention, the CSS and cylinder position are calculated using the PLC.

Regarding the gap setting this sensor detects the zero CSS when the curtain comes into contact with the Rotor while the cylinder is being extended. This zero CSS condition also allows the PLC to determine the total wear (topology changes through abrasion) and will allow the crusher curtain to be set to a pre-set valve/gap set by the operator via the PLC.

The system logic continually monitors the gap setting system and the total wear (topology changes through abrasion) is compensated for within the PLC in order to ensure accurate gap setting. Further to this, the system can predict wear rates for the users specific application and automatically give the user updates as to when the wear parts need replacing (Wear Prediction).

Historically it is known that the curtain liners wear at a reduced rate when compared to the beater elements attached to the rotor. However, it is difficult to measure the independent wear rates between these items. The logic contains a procedure that after every hammer or beater change, the PLC will record liner wear and keep this value stored, hence the liner wear over time can be calculated and extrapolated to give predicted liner wear rates.

The cylinder has a valve attached that will hold the cylinder position under normal operating conditions. This is a mechanical pre-set value that can be monitored by the PLC and allow the hydraulic cylinder to be repositioned if certain conditions are not met and then reset again once the correct conditions are restored.

Further to this the system logic is set up to monitor primary and secondary curtain settings. This logic controls limits the hydraulic cylinder travel to a specific range applicable to either primary or secondary position.

The invention is not limited to the embodiments hereinbefore described but may be varied in both construction and detail.

1. A horizontal shaft impact crusher comprising:
a crusher housing having an inlet for material to be crushed, an outlet for material that has been crushed, an impeller being mounted on a horizontal shaft in the crusher housing and being operative for rotating around a horizontal axis, a curtain against which material accelerated by the impeller may be crushed; and
an adjustment device comprising:
an adjustment bar arranged for adjusting a position of said curtain relative to the impeller;
a cross beam to which said adjustment bar is connected, said crossbeam being adjustable relative to the impeller; and
a drive cylinder arranged for displacing the cross beam to set the position of the curtain relative to the impeller, wherein the drive cylinder includes an internally mounted sensor arranged to measure the curtain position relative to the impeller.

2. The horizontal shaft impact crusher as claimed in claim 1, wherein the drive cylinder is a hydraulic drive cylinder.

3. The horizontal shaft impact crusher as claimed in claim 1, wherein the internally mounted sensor is centrally mounted in the drive cylinder.

4. The horizontal shaft impact crusher as claimed in claim 1, wherein the internally mounted sensor is a magnetostrictive linear position sensor.

5. The horizontal shaft impact crusher as claimed in claim 1, wherein the internally mounted sensor measures stroke distance of the drive cylinder.

6. The horizontal shaft impact crusher as claimed in claim 5, wherein measurement of the stroke distance provides a linear distance between an impeller beater element and the curtain.

7. The horizontal shaft impact crusher as claimed in claim 5, wherein measurement of the stroke distance provides a measure of wear on the curtain.

8. The horizontal shaft impact crusher as claimed in claim 5, wherein the stroke distance is constantly measured by the internally mounted sensor.

9. The horizontal shaft impact crusher as claimed in claim 5, wherein measurement of the stroke distance is used to set the position of the curtain with respect to the impeller beater element to give a requested closed side setting gap.

10. The horizontal shaft impact crusher as claimed in claim 1, wherein the drive cylinder includes a holding side and a retraction side and a control block configured to reroute fluid from the holding side to the retraction side of the drive cylinder.

11. The horizontal shaft impact crusher as claimed in claim 10, wherein the control block reroutes fluid from the holding side to the retraction side of the cylinder, in response to an overload pressure, via a relief valve.

12. The horizontal shaft impact crusher as claimed in claim 1, wherein a pressure sensor measures a mechanical load acting on the curtain.

13. The horizontal shaft impact crusher according to claim 7, wherein the crusher is configured to store wear measurements, and to calculate, based on the stored wear measurements, a wear rate of a liner of the curtain and beater elements of the crusher, and to calculate, using the stored wear measurements, an estimated lifespan of the liners and beater elements.

14. (canceled)

15. The horizontal shaft impact crusher according to claim 9, wherein the crusher is configured to continually monitor the closed side setting gap and to compensate for wear to ensure an accurate closed side setting gap setting, and to continually monitor the closed side setting gap and predict wear rates for a user specific application, and optionally, to provide an indication as to when the wear parts need replacing.

16. (canceled)

17. The horizontal shaft impact crusher according to claim 15, wherein the crusher is further configured to:
provide a value of liner wear after a beater change;
record said value of liner wear;
calculate liner wear over time; and
extrapolate said liner wear over time to provide predicted curtain liner wear rates.

18. A method for adjusting a horizontal shaft impact crusher comprising a crusher housing having an inlet for material to be crushed, an outlet for material that has been crushed, an impeller being mounted on a horizontal shaft in the crusher housing and being operative for rotating around a horizontal axis, a curtain against which material accelerated by the impeller may be crushed, and an adjustment device for adjusting the position of said curtain relative to the impeller, the method comprising:
moving, by means of a drive cylinder, the curtain into a position at which the curtain is in contact with an impeller beater element; and
measuring a stroke of the drive cylinder using a sensor, which is internally mounted in the drive cylinder to calculate a position of the curtain relative to an impeller beater element.

19. The method as claimed in claim 18, wherein measurement of the stroke distance provides a measure of total combined wear on the curtain and impeller beater element, and to set the position of the curtain with respect to the impeller beater element.

20. (canceled)

21. The method as claimed in claim 18, further comprising one or more of:
periodically providing said measure of wear and storing the measurements;
calculating wear rate of beater elements and liners of the curtain;
calculating an estimated lifespan of the beater elements and liners of the curtain

22. (canceled)

23. The method according to claim 18, further comprising one or more of:
continually monitoring a closed side setting gap;
compensating for total combined wear within a machine programmable logic controller of the crusher to ensure an accurate closed side setting gap setting;
continually monitoring the closed side setting gap and predicting wear rates for a user specific application;
optionally, provide an indication as to when the wear parts need replacing.

24. (canceled)

25. The method according to claim 18, further comprising one or more of:
determining a value of liner wear after a beater change;
recording said value of liner wear;
calculating liner wear over time;
extrapolating said liner wear over time to provide predicted liner wear rates.
